(19) United States
(12) Patent Application Publication
(10) Pub. No.: US 2020/0147785 A1
(43) Pub. Date: May 14, 2020

(54) PARALLEL LINK ROBOT

(71) Applicant: FANUC CORPORATION, Yamanashi (JP)

(72) Inventor: Masahiro YAMAMOTO, Yamanashi (JP)

(73) Assignee: FANUC CORPORATION, Yamanashi (JP)

(21) Appl. No.: 16/575,824

(22) Filed: Sep. 19, 2019

(30) Foreign Application Priority Data
Nov. 13, 2018 (JP) 2018-212649

(51) Int. Cl. B25J 9/00; B25J 17/02; F16H 21/50

(52) U.S. Cl. CPC B25J 9/0051; F16H 21/50; B25J 17/0266

(57) ABSTRACT

A parallel link robot includes: a base having two or more actuators; a movable part; two or more link parts connected to the actuators; an orientation changing mechanism that changes the orientation of an element attached to the movable part; two or more additional actuators that are provided on the two or more link parts and that change the orientation of the element with the same degree of freedom; and power transmission shafts. The link parts each have a driving link and two parallel driven links. The additional actuators are each disposed between the driven links of the two or more link parts. The power transmission shafts extend from the additional actuators along the driven links and are connected, with universal joints, to shafts extending from the orientation changing mechanism. The universal joints are located on a straight line connecting intersections between the two driven links and the movable part.

### CROSS-REFERENCE TO RELATED APPLICATIONS

This application is based on Japanese Patent Application No. 2018-212649, filed on Nov. 13, 2018, the contents of which are incorporated herein by reference.

### FIELD

The present invention relates to a parallel link robot.

### BACKGROUND

A known parallel link robot in the related art includes: a base in which three motors are provided; a movable part disposed below the base; and three arms that connect the base and the movable part to each other in parallel and that are driven by the motors (for example, see Japanese Patent No. 4653848 and Japanese Patent No. 5576912). Each arm includes a driving link connected to a motor, and two parallel driven links that connect the driving link and the movable part.

The movable part includes an orientation changing mechanism that changes the orientation of an element attached to the movable part. An additional actuator disposed parallel to the driven link, and a power transmission shaft that transmits the rotary driving power from the additional actuator to the orientation changing mechanism are attached between the two driven links of one or more arms.

### SUMMARY

An aspect of the present invention is a parallel link robot including: a base having two or more actuators and fixed to an external structure; a movable part that can move relative to the base; two or more link parts connected to the actuators of the base; an orientation changing mechanism that changes the orientation of an element attached to the movable part; two or more additional actuators provided on two or more link parts to change the orientation of the element with the same degree of freedom; and power transmission shafts that transmit rotary driving power from the additional actuators to the orientation changing mechanism. The link parts each include a driving link that is connected to a corresponding one of the actuators and that has one degree of freedom with respect to the base, and two driven links that are disposed parallel to each other and connect the driving link and the movable part. The additional actuators are disposed between the driven links of two or more link parts. The power transmission shafts extend from the additional actuators along the driven links and are joined, with universal joints, to shafts extending from the orientation changing mechanism. The universal joints are located on a straight line connecting intersections between the two driven links and the movable part.

### BRIEF DESCRIPTION OF THE DRAWINGS

FIG. 1 is a perspective view of a parallel link robot according to an embodiment of the present invention.

FIG. 2 is an enlarged view of an auxiliary link and an additional actuator of the parallel link robot in FIG. 1.

FIG. 3 schematically shows a state of driven links and the auxiliary link in a state in which a movable part of the parallel link robot in FIG. 1 is disposed directly below a base.

FIG. 4 schematically shows a state of the driven link and the auxiliary link in a state in which the movable part in FIG. 3 has moved in the horizontal direction.

FIG. 5 schematically shows the structure of a wrist shaft of the parallel link robot in FIG. 1.

### DETAILED DESCRIPTION

A parallel link robot 1 according to an embodiment of the present invention will be described below with reference to the drawings.

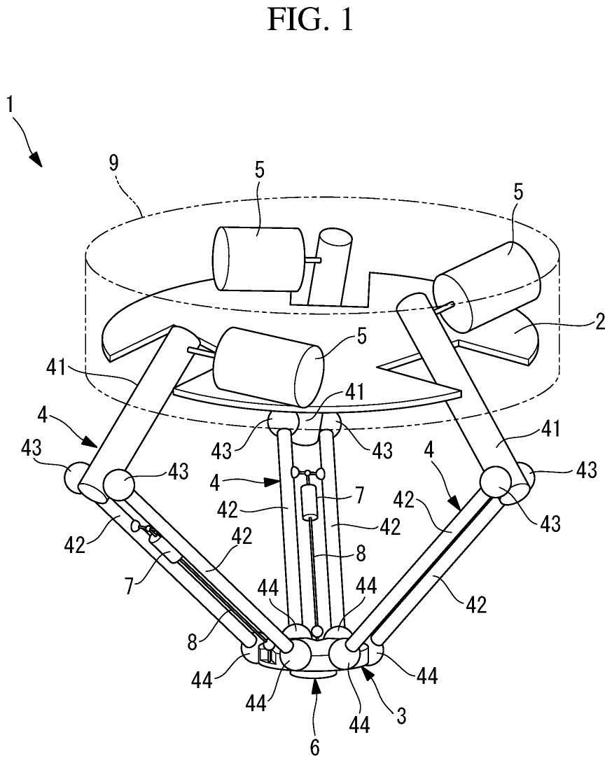

As shown in FIG. 1, the parallel link robot 1 according to this embodiment includes: a base 2 accommodated in the housing 9; a disc-shaped movable part 3 disposed below the base 2; three arms (link parts) 4 that connect the base 2 and the movable part 3 in parallel; three actuators 5 that are provided in the base 2 and respectively drive the three arms 4; a wrist shaft 6 that is provided on the movable part 3; additional actuators 7 for driving the wrist shaft 6; and drive shafts (power transmission shafts) 8.

The housing 9 and the base 2 are circular members (in plan view) that are fixed to an external structure (not shown) disposed above the parallel link robot 1 and to which the three actuators 5 for driving the three arms 4 are fixed. The three actuators 5 each include a servo motor and a reduction gear (not shown), are disposed at equal intervals in the circumferential direction around the central axis of the base 2, and have horizontal rotary driving shafts that are disposed so as to extend in directions tangential to a circle around the central axis of the base 2.

The arms 4 each have a driving link 41 that is fixed to the rotary driving shaft of the corresponding actuator 5 at one end, and two parallel driven links 42 that connect the other end of the driving link 41 and the movable part 3. The driving link 41 and the driven links 42 are connected to each other by spherical bearings 43, and the driven links 42 and the movable part 3 are connected to each other by spherical bearings 44.

The four spherical bearings 43 and 44, which are disposed at both ends of the two driven links 42 of each arm 4, are disposed such that the rectangular shape having the spherical bearings 43 and 44 at the corners forms a parallelogram.

With this configuration, the three arms 4 are disposed at equal intervals in the circumferential direction about the central axis of the base 2. By independently controlling the three actuators 5, it is possible to translate and position the movable part 3 to a desired position in three-dimensional directions, which include two horizontal directions and one vertical direction, while being held horizontally.

As shown in FIG. 1, in this embodiment, additional actuators 7 are provided on two arms 4.

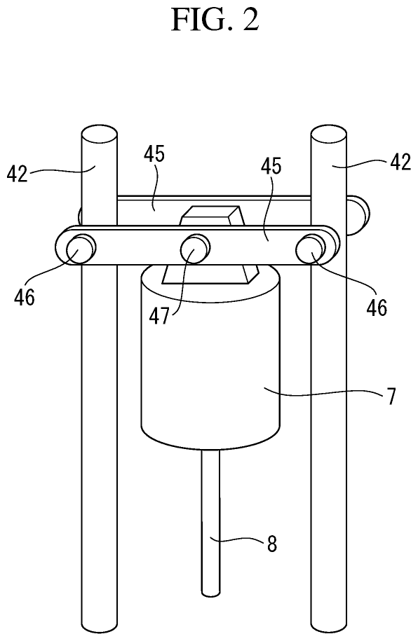

As shown in FIG. 2, the two driven links 42 of each arm 4 are connected to each other by auxiliary links 45 provided at an intermediate position in the longitudinal direction of the driven links 42. Both ends of the auxiliary links 45 are connected to the driven links 42 with bearings 46 so as to be rotatable about axes perpendicular to a plane including the longitudinal axes of the two driven links 42.

The additional actuators 7 are each connected, with a bearing 47, to the central portions of the auxiliary links 45 in the longitudinal direction so as to be rotatable about an axis parallel to the axes of the bearings 46 at both ends of the auxiliary links 45. The additional actuator 7 also includes a motor and a reduction gear (not shown) and has an output shaft that is rotatable about an axis parallel to the longitudinal direction of the driven links 42.

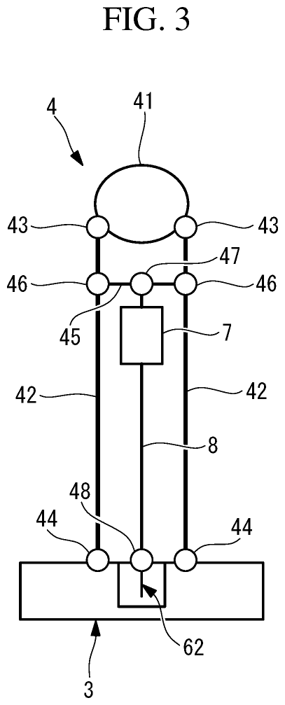

As shown in FIG. 3, the drive shaft 8 is fixed at one end to the output shaft of the additional actuator 7 and extends between the two driven links 42 so as to be parallel to the driven links 42.

As shown in FIGS. 3 to 5, the other end of the drive shaft 8 is connected to a shaft 62a of an orientation changing mechanism 62 (described below) with a universal joint 48. It is desirable that the central point of the universal joint 48 be located on a straight line connecting the central points of the two spherical bearings 44, which connect the two driven links 42 and the movable part 3.

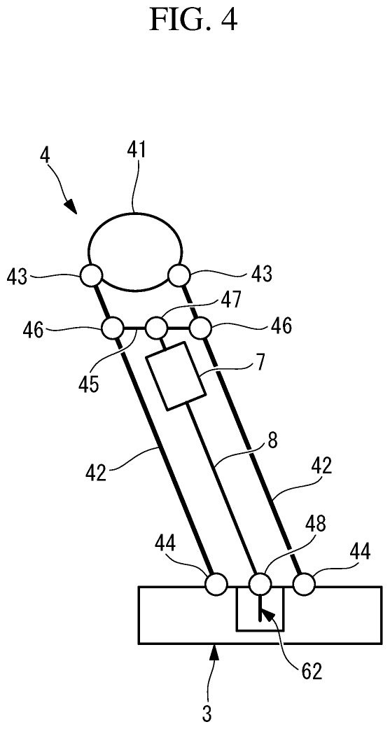

FIGS. 3 and 4 show the operations of the driven links 42, the auxiliary links 45, the additional actuators 7, and the drive shafts 8 when the movable part 3 is moved in a horizontal direction. FIG. 3 shows a state in which the central axis of the movable part 3 and the central axis of the base 2 are aligned, and FIG. 4 shows a state in which the movable part 3 is moved in a horizontal direction from the state in FIG. 3.

Regardless of the position of the movable part 3, the driven links 42, the additional actuator 7, and the drive shaft 8 are maintained parallel to each other.

The wrist shaft 6 includes a disc-shaped attachment member (element) 61 that is supported by the movable part 3 so as to be rotatable about the central axis of the movable part 3, and the orientation changing mechanism 62 that rotationally drives the attachment member 61 about the central axis.

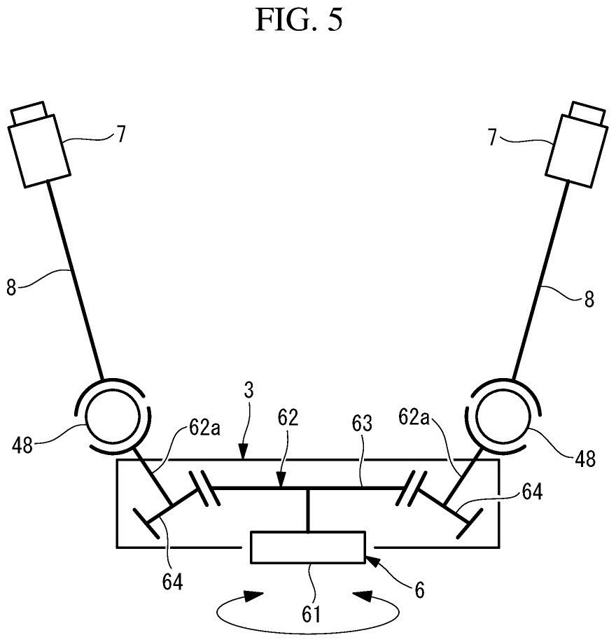

As shown in FIG. 5, the orientation changing mechanism 62 is accommodated in the movable part 3 and is fixed to the attachment member 61. The orientation changing mechanism 62 has a first gear 63, which is a bevel gear supported so as to be rotatable about the central axis of the attachment member 61 relative to the movable part 3, and two second gears 64, which are bevel gears meshing with the first gear 63.

Shaft parts 62a of the two second gears 64 project obliquely upward through the movable part 3 and, as described above, are connected to the other ends of the drive shafts 8 with the universal joints 48.

Two motors, which constitute the two additional actuators 7 for driving the two second gears 64 meshing with the single first gear 63, are driven by the same torque instruction. Specifically, the two additional actuators 7 are controlled in tandem on the basis of a single torque instruction. With this configuration, the two second gears 64 both reliably and simultaneously mesh with the first gear 63, and the two actuators 7 reliably share the driving torque of the first gear 63.

The operation of the thus-configured parallel link robot 1 according to this embodiment will be described below.

In the parallel link robot 1 according to this embodiment, when the three actuators 5 provided on the base 2 fixed to the external structure are driven, the three driving links 41 are pivoted about the rotary driving shafts of the corresponding actuators 5 with one degree of freedom.

When the driving links 41 are pivoted by means of independent control, the two driven links 42 connected to the end of each driving link 41 with the spherical bearings 43 are pivoted in a driven manner between the driving links 41 and the movable part 3 while maintaining a parallel relationship. As a result, the movable part 3 is moved in two horizontal directions and one vertical direction, that is, with three degrees of freedom, and is positioned at a desired position.

When the two additional actuators 7 are simultaneously actuated by means of tandem control, the two second gears 64 connected to the drive shafts 8 of the two additional actuators 7 with the universal joints 48 simultaneously mesh with the first gear 63 and transmit power, rotating the attachment member 61 about the vertical axis relative to the movable part 3. As a result, it is possible to change the orientation of a tool (not shown) attached to the attachment member 61 about the vertical axis with the positioned movable part 3 remaining fixed.

In this case, because the power for rotating the attachment member 61 is output not by a single additional actuator 7, but by two additional actuators 7 in a shared manner, it is possible to increase the power while avoiding an increase in size of the additional actuators 7, which is advantageous.

More specifically, because there is no need to increase the size of the additional actuators 7, there is no need to increase the rigidity of the auxiliary links 45 and the driven links 42, to which the additional actuators 7 are attached. There is an advantage in that it is also possible to prevent an increase in size of the driving links 41, to which the driven links 42 are connected, and the actuators 5 for supplying power to the driving links 41.

When the additional actuator 7 of one arm 4 is increased in size, the weight balance among the three arms 4 becomes worse, potentially leading to a loss of accelerating/decelerating performance depending on the moving direction of the movable part 3. However, because the weight of the additional actuators 7 is shared by the two arms 4, such an inconvenience does not occur, which is also advantageous.

In this embodiment, the additional actuators 7, which have a relatively large weight, are disposed at positions of the driven links 42 near the driving links 41, and the power is transmitted by the relatively light drive shafts 8. Hence, the accelerating/decelerating performance of the movable part 3 is not deteriorated.

In this embodiment, because the bevel gears are used as the first gear 63 and the second gears 64, it is easy to tilt the shafts 62a of the two second gears 64 in directions away from each other towards the upper side. This facilitates the connection between the second gears 64 and the drive shafts 8, which are inclined in directions closer to each other towards the distal ends and are provided along the driven links 42, with the universal joints 48, which leads to an advantage in that it is possible to ensure a wide operation area of the movable part 3.

Although an example of a delta-type parallel link robot 1 having three arms 4 has been described in this embodiment, instead, the present invention may be applied to another type of parallel link robot having two or more arms 4.

Although an example case where the additional actuators 7 are attached to two arms 4 of the three arms 4 has been described, instead, it is also possible to attach the additional actuators 7 to all three arms 4 and to allow three second gears 64 to simultaneously mesh with the first gear 63.

Although an example case where the wrist shaft 6 changes the orientation of the attachment member 61 about the vertical axis by means of two additional actuators 7 has been described, instead, the invention may be applied to the case where the wrist shaft 6 changes the orientation of the attachment member 61 about the horizontal axis. Although an example case where the wrist shaft 6 has one degree of freedom has been described, instead, the invention may be applied to the case where the wrist shaft 6 has two degrees of freedom, and a change in orientation of the attachment member 61 with either one degree of freedom or two degrees of freedom may be carried out by the two additional actuators 7.

Although the orientation changing mechanism 62 described above as an example has a structure in which the first gear 63 meshes with the second gears 64, the structure is not limited thereto, and any other mechanism may be used. The first gear 63 and the second gears 64 do not necessarily have to be bevel gears.

As a result, the following aspect is derived from the above described embodiment.

An aspect of the present invention is a parallel link robot including: a base having two or more actuators and fixed to an external structure; a movable part that can move relative to the base; two or more link parts connected to the actuators of the base; an orientation changing mechanism that changes the orientation of an element attached to the movable part; two or more additional actuators provided on two or more link parts to change the orientation of the element with the same degree of freedom; and power transmission shafts that transmit rotary driving power from the additional actuators to the orientation changing mechanism. The link parts each include a driving link that is connected to a corresponding one of the actuators and that has one degree of freedom with respect to the base, and two driven links that are disposed parallel to each other and connect the driving link and the movable part. The additional actuators are disposed between the driven links of two or more link parts. The power transmission shafts extend from the additional actuators along the driven links and are joined, with universal joints, to shafts extending from the orientation changing mechanism. The universal joints are located on a straight line connecting intersections between the two driven links and the movable part.

According to this aspect, it is possible to add the additional actuators up to the number of the link parts, increasing the degree of freedom of the parallel link robot. By actuating the additional actuators, it is possible to transmit the rotary driving power generated by the additional actuators to the movable part through the power transmission shafts and, thus, to change the orientation of the element attached to the movable part.

In this case, because the additional actuators are disposed between the driven links of the two or more link parts, and the additional actuators change the orientation of the movable part with the same degree of freedom, even when a large load is applied to the movable part, it is possible to make the plurality of additional actuators share the rotary driving power for driving the movable part. Specifically, even when the movable part requires large power, the power for changing the orientation of the element attached to the movable part can be increased without increasing the sizes of the additional actuators, the driven links, the driving links, and the actuators provided on the base.

In this aspect, the orientation changing mechanism may include a first gear that is fixed to the element of the movable part, and two or more second gears that mesh with the first gear. The shafts may be fixed to the second gears.

With this configuration, the rotary driving power from the additional actuators is transmitted to the shafts of the orientation changing mechanism through the power transmission shafts with the universal joints and is then transmitted to the element of the movable part by the first gear, with which two or more second gears fixed to the two or more shafts simultaneously mesh, and thus, it is possible to change the orientation of the element.

In this aspect, the driven links of the two or more link parts may be disposed so as to extend in directions closer to each other from the driving link towards the movable part, and the first gear and the second gears may be bevel gears.

With this configuration, it is possible to easily transmit the rotary driving power from the power transmission shafts disposed along the driven links inclined in one direction to the movable part by means of meshing between the bevel gears, and thus, to ensure a large movable area of the movable part.

1. A parallel link robot comprising:
a base having two or more actuators, the base fixed to an external structure;
a movable part that can move relative to the base;
two or more link parts connected to the actuators of the base;
an orientation changing mechanism that changes the orientation of an element attached to the movable part;
two or more additional actuators provided on two or more link parts to change the orientation of the element with the same degree of freedom; and
power transmission shafts that transmit rotary driving power from the additional actuators to the orientation changing mechanism, wherein
the link parts each include a driving link that is connected to a corresponding one of the actuators and that has one degree of freedom with respect to the base, and two driven links that are disposed parallel to each other and connect the driving link and the movable part,
the additional actuators are disposed between the driven links of the two or more link parts,
the power transmission shafts extend from the additional actuators along the driven links and are joined, with universal joints, to shafts extending from the orientation changing mechanism, and
the universal joints are located on a straight line connecting intersections between the two driven links and the movable part.

2. The parallel link robot according to claim 1, wherein
the orientation changing mechanism includes a first gear that is fixed to the element of the movable part, and two or more second gears that mesh with the first gear, and
the shafts are fixed to the second gears.

3. The parallel link robot according to claim 2, wherein
the driven links of the two or more link parts are disposed so as to extend in directions closer to each other from the driving link towards the movable part, and
the first gear and the second gears are bevel gears.
